(19) United States
(12) Patent Application Publication
(10) Pub. No.: US 2020/0201378 A1
(43) Pub. Date: Jun. 25, 2020

(54) LEVER-TYPE INPUT DEVICE

(71) Applicant: ALPS ALPINE CO., LTD., Tokyo (JP)

(72) Inventor: Tsuyoshi KIKUCHI, Miyagi (JP)

(21) Appl. No.: 16/693,653

(22) Filed: Nov. 25, 2019

(30) Foreign Application Priority Data
Dec. 20, 2018 (JP) 2018-238718

(51) Int. Cl. G05G 1/10; H01H 19/14; G05G 1/04

(52) U.S. Cl. CPC G05G 1/10; H01H 2231/026; G05G 1/04; H01H 19/14

(57) ABSTRACT

A lever-type input device includes a lever having a shaft at a tip, and an operation knob of a cap-shape configured to be attached to the shaft. The operation knob includes a cylindrical bearing extending along an axis of the shaft. The bearing is configured to be fitted with the shaft by the shaft being inserted into the bearing from an opening of the operation knob. The bearing includes an elastically deformable cantilever extending along the axis of the shaft. The cantilever includes a fixed end at one end located at a side of the opening, and a free end at an opposite side with respect to the fixed end. The free end includes a hook configured to engage an engagement groove formed on an outer peripheral side surface of the shaft.

### CROSS-REFERENCE TO RELATED APPLICATIONS

This patent application is based on and claims priority to Japanese Patent Application No. 2018-238718 filed on Dec. 20, 2018, the entire contents of which are incorporated herein by reference.

### BACKGROUND OF THE INVENTION

### 1. Field of the Invention

The present disclosure relates to a lever-type input device.

### 2. Description of the Related Art

Conventionally, in a vehicle such as an automobile, a lever-shaped input device (lever-type input device) provided on a steering column is used as an input device for a user (driver). A driver of the vehicle can operate various types of electrical equipment (such as a headlamp, a flasher, and a windshield wiper) provided in the vehicle, by operating the lever-type input device.

Some input devices provided in a vehicle have a knob at an end of the input device. By operating the knob, a driver of the vehicle can operate various types of electrical equipment provided in the vehicle. With respect to such input devices, a technique in which a knob can be easily attached to the input device has been developed, by adopting what is called snap-fit.

For example, Patent Document 1 discloses a knob attaching structure for a slider volume control employing snap-fit design. In the slider volume control disclosed in Patent Document 1, a notch provided in a slide knob guide groove is fitted with an engaging protrusion provided in an inner wall of a slide knob, so that the slide knob can be easily mounted to the slider volume control slidably.

However, in the technique disclosed in Patent Document 1, when a force is applied to the slide knob in a direction in which the slide knob is pulled, an inner wall of the slide knob is elastically deformed in a direction in which the slide knob is opened due to a rotational moment applied to the inner wall of the slide knob. Thus, the engaging protrusion may be disengaged, and the slide knob may come off.

### PATENT DOCUMENT

### [Patent Document 1] Japanese Unexamined Utility Model Application Publication No. 62-073502

### SUMMARY OF THE INVENTION

A lever-type input device includes a lever having a shaft at a tip, and an operation knob of a cap-shape configured to be attached to the shaft. The operation knob includes a cylindrical bearing extending along an axis of the shaft. The bearing is configured to be fitted with the shaft by the shaft being inserted into the bearing from an opening of the operation knob. The bearing includes an elastically deformable cantilever extending along the axis of the shaft. The cantilever includes a fixed end at one end located at a side of the opening, and a free end at an opposite side with respect to the fixed end. The free end includes a hook configured to engage an engagement groove formed on an outer peripheral side surface of the shaft.

### BRIEF DESCRIPTION OF THE DRAWINGS

FIG. 1 is a perspective view of a stalk switch device according to an embodiment;

FIG. 2 is a perspective view of the stalk switch device according to the embodiment;

FIG. 3 illustrates an internal structure of an operation knob according to the embodiment;

FIG. 4 is a cross-sectional view illustrating an attaching structure of the operation knob according to the embodiment;

FIG. 5 a schematic diagram illustrating behavior of cantilevers in the operation knob according to the embodiment;

FIG. 6 is a cross-sectional view illustrating an arrangement of hooks in the operation knob according to the embodiment; and

FIG. 7 illustrates an example of a method for producing the cantilevers equipped with the operation knob according to the embodiment.

### DETAILED DESCRIPTION OF THE PREFERRED EMBODIMENTS

Hereinafter, an embodiment of the present disclosure will be described with reference to drawings. Note that, in description of the present embodiment, a Z-axis direction illustrated in the drawings is referred to as an up-and-down direction, a Y-axis direction in the drawings is referred to as a left-and-right direction, and an X-axis direction in the drawings is referred to as a back-and-forth direction.

(Abstract of Stalk Switch Device 10)

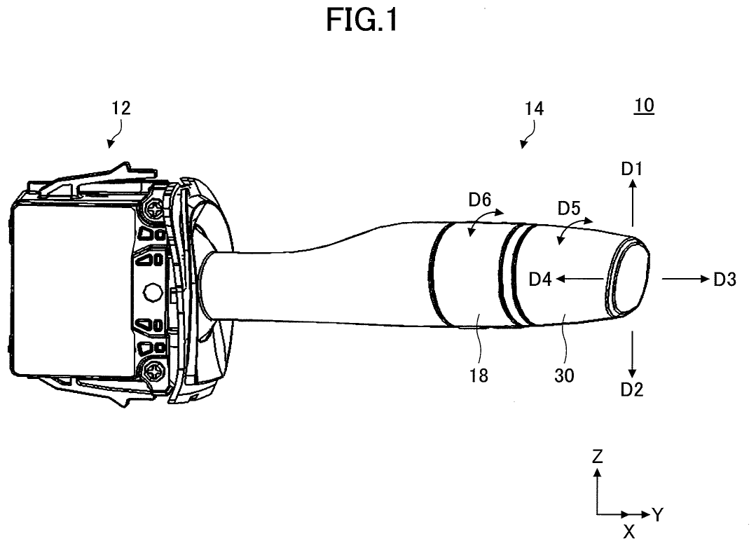

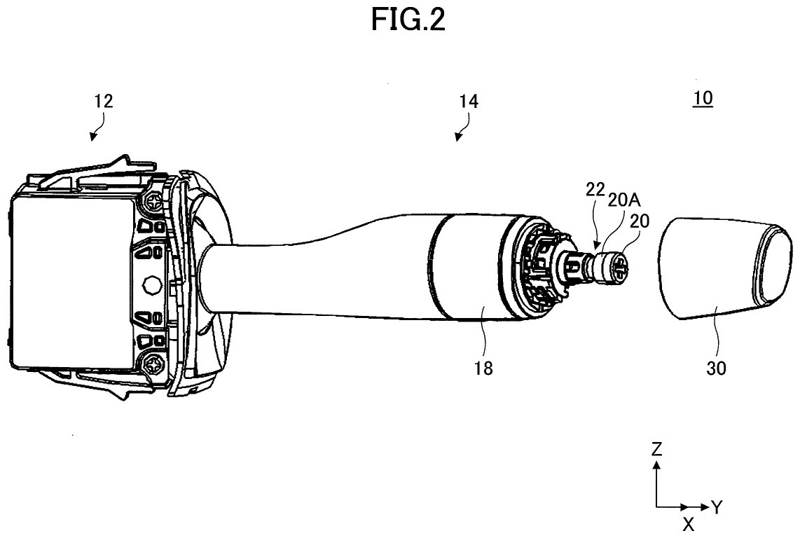

FIGS. 1 and 2 are perspective views of a stalk switch device 10 according to an embodiment. In FIG. 1, a stalk switch device 10 is illustrated in which an operation knob 30 is attached to a lever 14. FIG. 2 illustrates the stalk switch device 10 in a state in which the operation knob 30 is removed from the lever 14.

The stalk switch device 10 illustrated in FIG. 1 or 2 is an example of a “lever-type input device”, and is fixed to a steering column (not illustrated) of a vehicle such as an automobile. The stalk switch device 10 is electrically connected to various electrical components (such as a headlamp, a flasher, and a windshield wiper) provided in the vehicle, and can be operated by a user to change operations of the various electrical components.

The stalk switch device 10 includes a base 12 and the lever 14. The base 12 is a portion which is fitted and fixed to the steering column of the vehicle. The lever 14 substantially extends, from the steering column, in a linear direction toward the radial direction of the steering wheel (not illustrated), and the lever 14 is used for operating various switches for switching operations of various electrical components. The lever 14 is supported by the base 12, such that the lever 14 can be tilted by a user (driver) in each of the following directions: an upward direction (Z-axis positive direction, D1 in the drawing), a downward direction (Z-axis negative direction, D2 in the drawing), a forward direction (X-axis positive direction, D3 in the drawing), and a backward direction (X-axis negative direction, D4 in the drawing).

At an end of the lever 14, the cap-like operation knob 30 is provided such that the operation knob 30 can be rotated in an axial rotation direction (D5 in the drawing) of a shaft 20 (see FIG. 2) provided in the lever 14. By a rotating operation to the operation knob 30 being made (i.e. by the operation knob 30 being rotated), an operation of an electrical component corresponding to the operation knob 30 can be switched. The meaning of “cap-like” shape in the present embodiment is not limited to a shape of the operation knob 30 according to the present embodiment, but includes a shape having at least a bottom surface and an outer wall surrounding the bottom surface to form an internal space, and having an opening on a surface facing the bottom surface.

In addition, an annular operation knob 18 is provided at a location near the end of the lever 14 and closer to the base 12 relative to the operation knob 30, so as to be rotatable in the axial rotation direction (D6 in the drawing) of the shaft 20 of the lever 14. By the operation knob 18 being rotated, an operation of an electrical component corresponding to the operation knob 18 can be switched.

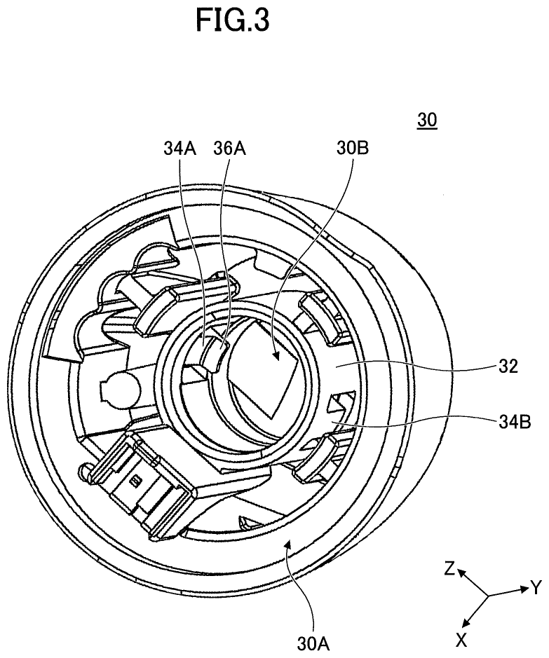

As illustrated in FIG. 2, the operation knob 30 can be fitted to the end of the lever 14. The shaft 20 is provided at the end of the lever 14. The operation knob 30 is attached to the end of the lever 14 by fitting the shaft 20 into a bearing 32 (see FIG. 3) provided in the operation knob 30. The operation knob 30 has a metal connection terminal (not illustrated) inside. Because a connection state of the connection terminal is changed by a rotating operation of the operation knob 30, an operation of the electrical component corresponding to the operation knob 30 can be switched.

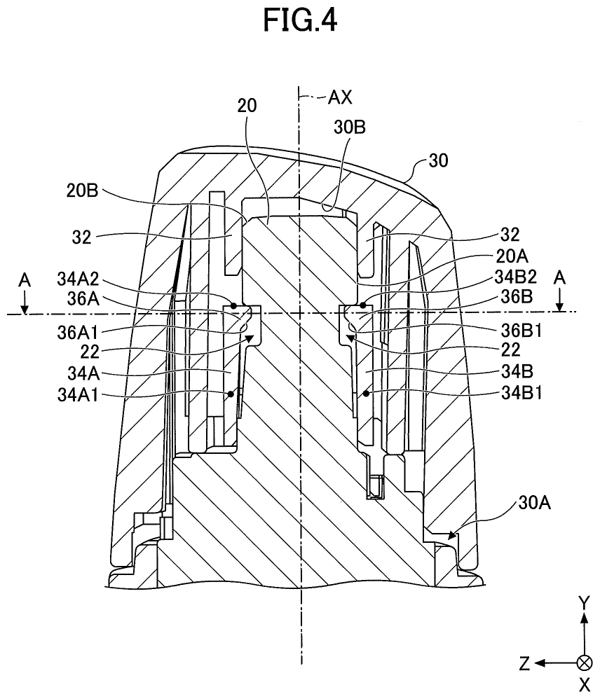

FIG. 3 is a diagram illustrating an internal structure of the operation knob 30 according to the present embodiment. FIG. 3 is a perspective view of the operation knob 30 viewed from a side of an opening 30A. As illustrated in FIG. 3, the operation knob 30 has a hollow cap shape. For example, the operation knob 30 is formed from synthetic resin material such as ABS (Acrylonitrile Butadiene Styrene), by a molding process using a mold such as injection molding. The operation knob 30 has the opening 30A on the side of the lever 14. The operation knob 30 also has the bearing 32 therein. The bearing 32 has a cylindrical shape extending along an axial direction of a central axis AX (see FIG. 4) of the shaft 20, from a deep bottom portion 30B of the operation knob 30 toward the opening 30A. The bearing 32 is fitted to the shaft 20 by inserting the cylindrical shaft 20 into an inside of the cylinder (bearing 32) from the opening 30A. An inner diameter of the bearing 32 is approximately the same as an outer diameter of the shaft 20.

A pair of elastically deformable cantilevers 34A and 34B extending linearly along the axial direction of the central axis AX of the shaft 20 is provided in the outer peripheral wall portion of the bearing 32, and the cantilever 34B is located at a position corresponding to a point reflection of the cantilever 34A across a point corresponding to the central axis AX when viewed in a cross-sectional view along the central axis AX (i.e. the cantilever 34A and the cantilever 34B are in a relation of point symmetry with respect to the point corresponding to the central axis AX when viewed in the cross-sectional view along the central axis AX). The cantilevers 34A and 34B have fixed ends 34A1 and 34B1 at the side of the opening 30A respectively, and have free ends 34A2 and 34B2 at the side of the deep bottom portion 30B respectively, and the free ends 34A2 and 34B2 have hooks 36A and 36B respectively that project toward the inside of the bearing 32. The hooks 36A and 36B engage an engagement groove 22 formed in an outer peripheral side surface 20A of the shaft 20. The engagement groove 22 is annularly formed along the circumferential direction at the outer peripheral side surface 20A of the shaft 20.

FIG. 4 is a cross-sectional view illustrating an attaching structure of the operation knob 30 according to the present embodiment. As illustrated in FIG. 4, the operation knob 30 is rotatably attached to the shaft 20 by inserting the shaft 20 from the opening 30A into the cylinder of the bearing 32. At this time, by the shaft 20 being pressed into the cylinder of the bearing 32, an end edge 20B of the shaft 20 comes into contact with sloping surfaces 36A1 and 36B1 of the hooks 36A and 36B that are located at a side of the opening 30A, so that the hooks 36A and 36B can be pressed outward. This allows the cantilevers 34A and 34B to elastically deform so as to deform outward, thus allowing the shaft 20 to be inserted between the hooks 36A, 36B. Further, when the shaft 20 is pushed until the engagement groove 22 reaches the hooks 36A and 36B, the pressure on the hooks 36A and 36B is released, and by the elastic restoring force of the cantilevers 34A and 34B, the cantilevers 34A and 34B are restored from an elastically deformed state in which the cantilevers 34A and 34B are outwardly deformed. Thus, as illustrated in FIG. 4, the operation knob 30 becomes in a state in which the hooks 36A and 36B engage the engagement groove 22, so that even when a force of pulling the operation knob 30 out of the shaft 20 is applied, the operation knob 30 does not easily come off the shaft 20.

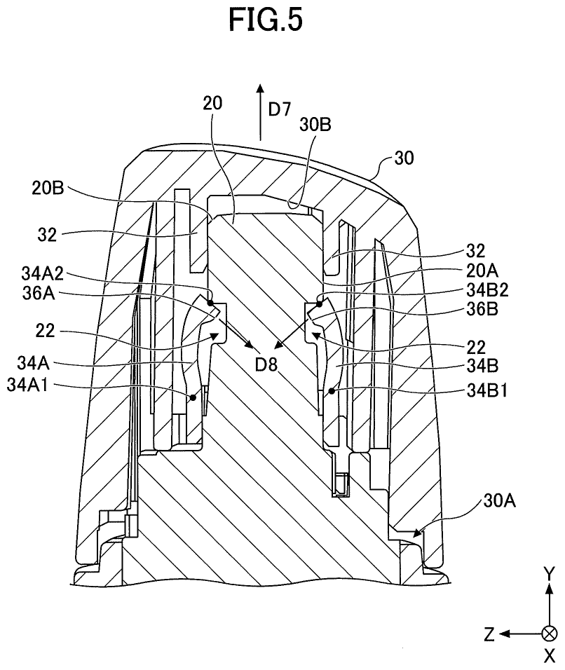

FIG. 5 is a schematic diagram illustrating behavior of the cantilevers 34A and 34B in the operation knob 30 according to the present embodiment. As described with reference to FIG. 4, the cantilevers 34A and 34B respectively have the fixed ends 34A1 and 34B1 at the side of the opening 30A, and have the free ends 34A2 and 34B2 at the side of the deep bottom portion 30B. Also, the cantilevers 34A and 34B are elastically deformable. Accordingly, as illustrated in FIG. 5, when a force is applied to the operation knob 30 in a direction in which the operation knob 30 is pulled out of the shaft 20 (D7 in the drawing), end surfaces of the cantilevers 34A and 34B (surfaces facing the deep bottom portion 30B) are pressed toward the opening 30A by an inner wall of the engagement groove 22 that is located at the deep bottom portion 30B side, so that the end surfaces of the cantilevers 34A and 34B are pushed down toward the opening 30A. Thus, as illustrated in FIG. 5, as a moment (torque) is applied to each of the cantilevers 34A and 34B, stress for moving the hook 36A and the hook 36B in an inwardly oblique downward direction (D8) is applied to the end surfaces of the cantilevers 34A and 34B, thereby causing the cantilevers 34A and 34B to elastically deform inwardly so as to narrow the space between the hook 36A and the hook 36B. This results in a stronger engagement of the cantilevers 34A and 34B with respect to the engagement groove 22, thus making the operation knob 30 less likely to come off the shaft 20.

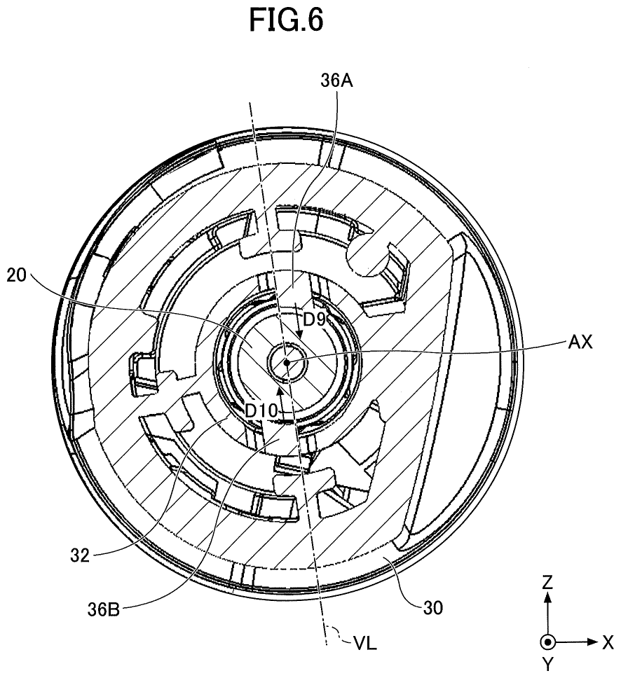

FIG. 6 is a cross-sectional view illustrating an arrangement of the hooks 36A and 36B in the operation knob 30 according to the present embodiment. FIG. 6 is a cross-sectional view of an end portion of the lever 14 (at which the hooks 36A and 36B are engaged with the engagement groove 22) taken along a line A-A illustrated in FIG. 4, and represents a cross-sectional view when viewed from the right end of the lever 14. A virtual dividing line VL illustrated in FIG. 6 is a straight line parallel to a direction of elastic deformation (D9 and D10 in the drawing) of the hooks 36A, 36B, which passes through the central axis AX of the shaft 20.

As illustrated in FIG. 6, in the bearing 32 of the operation knob 30, the hook 36A (and the cantilever 34A) is provided offset to one side from the virtual dividing line VL, and the hook 36B (and the cantilever 34B) is provided offset to the other side from the virtual dividing line VL.

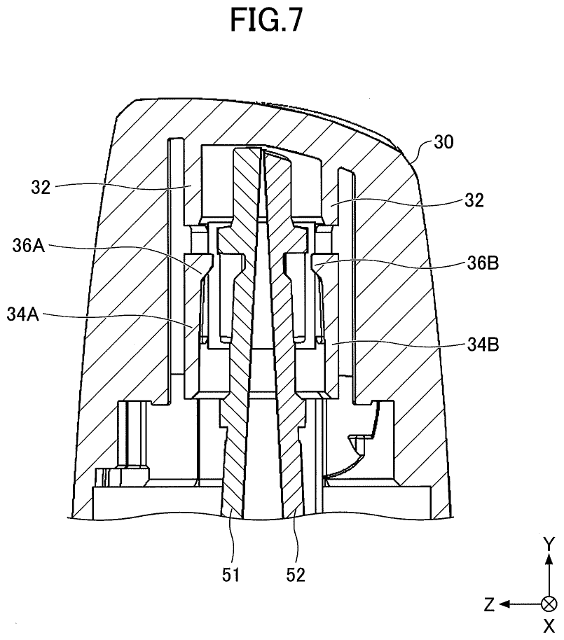

FIG. 7 illustrates an example of a resin molding method using a sliding core mold (hereinafter may be referred to as a “sliding core”) for producing the cantilevers 34A and 34B provided in the operation knob 30 according to the embodiment. For example, as illustrated in FIG. 7, by disposing two sliding cores 51 and 52, which can slide toward a direction closer to each other in the cylinder of the bearing 32, the cantilevers 34A, 34B with the protruding hooks 36A, 36B can be molded. The sliding core 51 extends within the cylinder of the bearing 32, and is disposed on a side of the cantilever 34A to form the cantilever 34A and the hook 36A. The sliding core 52 extends within the cylinder of the bearing 32, and is disposed on a side of the cantilever 34B to form the cantilever 34B and the hook 36B.

As illustrated in FIG. 6, because the cantilevers 34A and 34B are disposed so as to be offset, the sliding cores 51 and 52 can be similarly provided in the cylindrical portion of the bearing 32 so as to be offset when forming the cantilevers 34A and 34B. Thus, for example, when the cantilevers 34A and 34B are released from the sliding cores 51 and 52 by sliding the sliding cores 51 and 52 closer to each other, the sliding cores do not come into contact with each other at the front surface because the sliding cores 51 and 52 are offset from each other. That is, an amount of slide of the sliding cores 51 and 52 in a direction of mold release can be increased. Further, thickness of the sliding cores 51 and 52 in the direction of mold release can be increased, thereby increasing strength of the sliding cores 51 and 52. In particular, the above-described structure is useful when an inner diameter of the bearing 32 is relatively small.

Further, as illustrated in FIG. 6, portions of the hooks 36A and 36B that abut on the outer peripheral side surface 20A of the shaft 20 (a portion corresponding to a deep bottom surface of the engagement groove 22) protrude along an inner wall of the engagement groove 22 at the deep bottom portion 30B side, and are inclined with respect to a direction to which the hooks 36A and 36B are offset in the cross-sectional view (i.e. inclined with respect to a direction perpendicular to the virtual dividing line VL). According to the above-described structure, it is possible to increase an abutting area between the end surfaces of the cantilevers 34A and 34B (surfaces facing the deep bottom portion 30B) and the inner wall surface of the engagement groove 22 at the deep bottom portion 30B side. Therefore, it is possible to prevent the operation knob 30 from coming off the shaft 20 more certainly.

As described above, the stalk switch device 10 according to the present embodiment includes the lever 14 having the shaft 20 at a tip of the lever 14, and the cap-like operation knob 30 attached to the shaft 20. Inside the operation knob 30, the cylindrical bearing 32 extending along an axis of the shaft 20 is provided. The operation knob 30 is fitted with the shaft 20 by inserting the shaft 20 into the cylindrical bearing 32 from a side of the opening 30A of the operation knob 30. The bearing 32 includes the elastically deformable cantilevers 34A and 34B extending along the axis of the shaft 20. The cantilevers 34A and 34B respectively include the fixed ends 34A1 and 34B1 at the opening 30A side, and the free ends 34A2 and 34B2 at an opposite side with respect to the fixed ends 34A1 and 34B1. The free ends 34A2 and 34B2 have hooks 36A and 36B respectively, each of which is configured to engage the engagement groove 22 formed on the outer peripheral side surface 20A of the shaft 20.

Accordingly, in the stalk switch device 10 according to the present embodiment, the operation knob 30 can be attached to to the shaft 20 easily by pressing the operation knob 30 against the shaft 20. Further, in the stalk switch device 10 according to the present embodiment, when force is applied to the operation knob 30 in a direction of pulling the operation knob 30, the cantilevers 34A and 34B are elastically deformed inwards, due to a moment being applied to the cantilevers 34A and 34B, thereby making engagement of the cantilevers 34A and 34B with the engagement groove 22 stronger. Accordingly, the stalk switch device 10 according to the present embodiment is configured such that the operation knob 30 can be easily attached and that the operation knob 30 cannot be removed easily.

In the stalk switch device 10 according to the present embodiment, the engagement groove 22 is formed in an annular shape along a circumferential direction at the outer peripheral side surface 20A of the shaft 20, and the operation knob 30 is attached to the shaft 20 so as to be rotatable about the axis of the shaft 20.

Thus, the stalk switch device 10 according to the present embodiment is configured to allow a rotating operation of the operation knob 30. Also, the stalk switch device 10 according to the present embodiment is configured such that the operation knob 30 can be easily attached and that the operation knob 30 cannot be removed easily.

Also, in the stalk switch device 10 according to one embodiment, the bearing 32 has a pair of the cantilevers 34A and 34B. The cantilever 34B is located at a position corresponding to a point reflection of the cantilever 34A across a point corresponding to the central axis AX in a cross-sectional view viewed from the axial direction of the central axis AX.

According to the above-described structure of the stalk switch device 10 according to the present embodiment, a mounting state and a rotational operation of the operation knob 30 can be stabilized. In addition, when a pulling force is applied to the operation knob 30, the hooks 36A and 36B act to pinch the shaft 20, thereby making it more difficult to pull out the operation knob 30.

Further, in the stalk switch device 10 according to the present embodiment, one cantilever 34A out of the pair of the cantilevers 34A and 34B is provided offset to one side from the virtual dividing line VL passing through the central axis AX, and the other cantilever 34B out of the pair of the cantilevers 34A and 34B is provided offset to the other side from the virtual dividing line VL.

Accordingly, in the stalk switch device 10 according to the present embodiment, because the sliding cores 51 and 52 for forming the cantilevers 34A and 34B can be similarly provided so as to be offset, the sliding cores 51 and 52 do not come into contact with each other when the cantilevers 34A and 34B are released from the sliding cores 51 and 52. Therefore, in the stalk switch device 10 according to the embodiment, a large amount of movement of the sliding cores 51 and 52 in the releasing direction can be secured, so that the thickness of the sliding cores 51 and 52 in the releasing direction of the sliding cores 51 and 52 can be increased, thereby increasing strength of the sliding cores 51 and 52.

Also, in the stalk switch device 10 according to the present embodiment, the hooks 36A and 36B of the respective cantilevers 34A and 34B are concavely curved along the engagement groove 22 of the shaft 20.

This allows the stalk switch device 10 according to the embodiment to increase the abutting area between the cantilevers 34A and 34B and the engagement groove 22 when a force is applied to the operation knob 30 in a direction of pulling out the operation knob 30, thereby making the operation knob 30 more resistant to slipping out of the shaft 20.

While an embodiment of the present disclosure has been described in detail above, the present invention is not limited to the above-described embodiment, and various modifications or variations are possible within the scope of the invention as defined in the claims.

For example, the above-described embodiment illustrates the application of the present invention to a stalk switch device for a vehicle, but is not limited thereto. The present invention is applicable to any input device provided that at least the tip of the lever is provided with a detachable and cap-shaped operation knob.

The above-described embodiment describes a case in which the present invention is applied to a rotatable operation knob, but is not limited thereto. The present invention can also be applied to an operation knob that is incapable of rotating.

In the above-described embodiment, the operation knob is provided with two cantilevers. However, the operation knob may be provided with one cantilever, or the operation knob may be provided with three or more cantilevers. For example, the operation knob may be configured to have three cantilevers at 120° intervals, or the operation knob may be configured to have four cantilevers at 90° intervals.

In the above-described embodiment, the annular engagement groove 22 is provided in the outer peripheral side surface 20A of the shaft 20, but is not limited thereto. At least, an engagement groove of the present invention may cover the hook movable range associated with the rotation operation of the operation knob, and the engagement groove is not required to be a seamless ring.

What is claimed is:

1. A lever-type input device comprising:
a lever having a shaft at a tip; and
an operation knob of a cap-shape configured to be attached to the shaft; wherein
the operation knob includes a cylindrical bearing extending along an axis of the shaft, the bearing being configured to be fitted with the shaft by the shaft being inserted into the bearing, from an opening of the operation knob;
the bearing includes an elastically deformable cantilever extending along the axis of the shaft;
the cantilever includes a fixed end at one end located at a side of the opening, and a free end at an opposite side with respect to the fixed end; and
the free end includes a hook configured to engage an engagement groove formed on an outer peripheral side surface of the shaft.

2. The lever-type input device according to claim 1, wherein
the engagement groove is formed in an annular shape along a circumferential direction at the outer peripheral side surface of the shaft; and
the operation knob is attached to the shaft so as to be rotatable about the axis of the shaft.

3. The lever-type input device according to claim 2, wherein
the bearing includes a pair of a first cantilever and a second cantilever, each of the first cantilever and the second cantilever being the cantilever, and the second cantilever being located at a position corresponding to a point reflection of the first cantilever across a point corresponding to a central axis of the shaft, in a cross-sectional view viewed from an axial direction of the central axis.

4. The lever-type input device according to claim 3, wherein
the first cantilever is provided offset to one side from a virtual dividing line passing through the central axis, and
the second cantilever is provided offset to another side from the virtual dividing line.

5. The lever-type input device according to claim 4, wherein
the hook of each of the first cantilever and the second cantilever protrudes along an inner wall of the engagement groove, and is inclined with respect to a direction to which each of the first cantilever and the second cantilever is offset in the cross-sectional view.
